(19) United States
(12) Patent Application Publication
(10) Pub. No.: US 2024/0232614 A1
(43) Pub. Date: Jul. 11, 2024

(54) MACHINE LEARNING SYSTEMS AND METHODS FOR METADATA CLASSIFICATION OF ELECTRONIC DATA

(71) Applicant: THE TORONTO-DOMINION BANK, Toronto (CA)

(72) Inventors: NAHAL ESMAEILI, TORONTO (CA); MEHRNAZ MIRESLAMI, TORONTO (CA)

(21) Appl. No.: 18/094,856

(22) Filed: Jan. 9, 2023

(51) Int. Cl. G06N 3/08; G06N 3/0442

(52) U.S. Cl. CPC G06N 3/08; G06N 3/0442

(57) ABSTRACT

A computer implemented system and method is provided for predicting and classifying data warehouse metadata labels using deep machine learning. The system includes an input layer for receiving a first and second textual inputs characterizing different aspects of data fields for a data element; an embedding layer embedding the textual inputs separately and independently to a format suitable for long short term memory (LSTM) each provided to a separate LSTM model; a shared layer for concatenating the outputs from each LSTM and applying hard parameter sharing including hidden layers across all tasks; and, a task specific layer classifying the concatenated output into at least one of a possible set of tasks corresponding to separate metadata classifications using a set of simultaneously trained classifiers based on the hard parameter sharing. The multi-task learning model being a single model trained to simultaneously learn multiple classification tasks corresponding to different metadata classifications.

### FIELD

The present disclosure relates to computer-implemented metadata classifiers and more particularly to methods, systems, and devices for automatically generating real-time metadata classifications for tagging of data elements, such as for electronic data management systems.

### BACKGROUND

A huge concern in managing and maintaining electronic enterprise data warehouses (EDW) and associated electronic databases is the task of having accurate and easily interpretable metadata labels for processing by other computing systems. This task often requires inefficient manual intervention and coordination.

Metadata labelling is a task that has previously been done manually by the data stewards and has been a huge concern for data governance in terms of the time and resources that this process takes, as well as its inaccuracies. These may lead to security and privacy data leaks for unclassified data. Traditional systems also suffer from a lack of scalability. Another reason for effective metadata labelling is the need for data migration to cloud.

Migrating data elements, data workloads, websites, applications, and/or databases to computing clouds, such as Microsoft Azure™, Amazon EC2™, Bungee Connect™, Google App Engine™, and other computing cloud environments is computationally complex and often requires modifications made for compatibility, reliability, and efficiency of the cloud environment. Such data migration to computing cloud architectures has recently increased in use due to several advantages including: scalability, increased computing capabilities, flexibility of architecture, storage capacity, computing performance, etc. There may be defined prerequisites for cloud migration to reduce likelihood of issues in migration, which would lead to unnecessary wastage of additional computing resources, manual intervention, and compatibility issues altogether. Aspects of the data or applications may need to be changed or removed in order to allow them to operate within a computing cloud environment. Generally, cloud migration may include migrating digital assets from legacy infrastructures and data warehouses such as: a computer application, digital data, computing service, computer resources, computing workload, or task to be run on a cloud resource.

Additionally, there may be requirements to provide and verify metadata labels within electronic data, resources or applications for data security requirements or metadata labels may need to meet certain cloud migration rules or validation rules to be eligible for migration to computing cloud environments.

It is vital to provide metadata labels with correct content and it is helpful to do so simply, automatically and efficiently to avoid wasting computing resources and to allow efficient cloud migration.

### SUMMARY

It is an object of the disclosure to provide an automatic and real-time computerized metadata classifier, which automatically and accurately predicts metadata labels using neural networks, such as from data harvested across communication networks from enterprise data warehouses.

Such metadata information (e.g. electronic data fields) retrieved from electronic data warehouses may be incorrect, missing altogether and required either for data security, data privacy and/or to meet computing requirements and compatibility guidelines for migration of the data elements or application or computing resource, etc. to the computing cloud. There is also a need for the proposed metadata classifier to effectively operate and label large amounts of metadata (e.g. from enterprise data warehouses) accurately in live executing environments such as for migration to computing clouds.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a machine learning model for automatic metadata classification and labelling. The machine learning model also includes a multi-task machine learning model comprising: an input layer for receiving a first textual input characterizing one aspect or feature of metadata (e.g. data field) for an input data element; and receiving a second textual input characterizing another aspect or feature of metadata (e.g. data field) for the input data element; an embedding layer of the input layer, for embedding the first and second textual inputs separately and independently to a format suitable for long short term memory (LSTM) neural networks and each provided to a separate LSTM model in the input layer to generate a first and second output of the input layer respectively; a shared layer for receiving the first and second output of the input layer from each LSTM and concatenating the outputs to form a concatenated output, the shared layer applying hard parameter sharing for sharing model parameters including hidden layers across all tasks; and, a task specific layer for receiving the concatenated output including the hard parameter sharing to learn parameters specific to each task and classifying the concatenated output into at least one of a possible set of tasks corresponding to separate metadata classifications using a set of simultaneously trained classifiers, the multi-task machine learning model being a single model trained to simultaneously learn, during a training phase, multiple classification tasks corresponding to different metadata classifications. Other embodiments of this aspect include corresponding computer systems, apparatus, and computer programs recorded on one or more computer storage devices, each configured to perform the actions of the methods.

Implementations may include one or more of the following features. The machine learning model where the first textual input may include: a business name field and a description field for an input data element, and the second textual input may include: a malicious code field and a technical name field for the input data element. The machine learning model may include: an optimization layer coupled to the task specific layer, for receiving outputs from each task sublayer of a plurality of task sublayers providing multi-task classifiers provided in the task specific layer for determining an indication of a likelihood of an input to the task specific layer corresponding to one of the task sublayers, the outputs provided to a root mean square propagation in the optimization layer for increasing a learning rate for the task specific layer. The task specific layer applies deep multi-task learning and may include an input layer, a hidden layer and an output layer, each node in the output layer associated with a particular task of a set of tasks and sharing common features therebetween for optimization of the multi-task learning. In at least one aspect, the task specific layer applies a binary threshold to at least some output nodes to determine a likelihood of whether input to the task specific layer falls within the particular task for the output layer to provide the metadata classification. In at least one aspect, the task specific layer applies a soft max threshold to at least some output nodes to determine a likelihood of whether input to the task specific layer falls within the particular task associated with one of the output nodes. Implementations of the described techniques may include hardware, a method or process, or computer software on a computer-accessible medium.

One general aspect includes the machine learning model further includes a sequence to sequence deep learning model for converting metadata fields for data elements into a recognizable format for the multi-task machine learning model, the sequence to sequence model having an encoder layer, an attention layer and a decoder layer for receiving the data elements as a sequence containing textual input representing a first domain including a name with acronyms and translating to a second domain including an understandable text for each data element, the understandable text provided as input to the multi-task machine learning model for further processing as a further aspect of the metadata. Other embodiments of this aspect include corresponding computer systems, apparatus, and computer programs recorded on one or more computer storage devices, each configured to perform the actions of the methods.

Implementations may include one or more of the following features. The machine learning model where the sequence to sequence deep learning model further applies long short term memory as the encoder and the decoder layers. Implementations of the described techniques may include hardware, a method or process, or computer software on a computer-accessible medium.

One general aspect includes a computer-implemented method for metadata classification and labelling of data elements using machine learning. The computer-implemented method also includes receiving a first textual input, via an input layer of a multi-task machine learning model, for characterizing one aspect of metadata for an input data element; and receiving a second textual input characterizing another aspect of metadata for the input data element; embedding, via an embedding layer of the input layer, the first and second textual inputs separately and independently to a format suitable for long short term memory (LSTM) neural networks; providing each embedding to a separate LSTM model in the input layer to generate a first and second output of the input layer respectively; receiving the first and second output of the input layer from each LSTM model, at a shared layer coupled to the input layer, and concatenating the outputs to form a concatenated output, the shared layer applying hard parameter sharing for sharing model parameters including hidden layers across all tasks; and receiving, at a task specific layer coupled to the shared layer, the concatenated output for including the hard parameter sharing to learn parameters specific to each task and classifying, at the task specific layer, the concatenated output into at least one of a possible set of tasks corresponding to separate metadata classifications using a set of simultaneously trained classifiers, the multi-task machine learning model being a single model trained to simultaneously learn, during a training phase, multiple classification tasks corresponding to different metadata classifications; and automatically tagging the input data element with the metadata classifications. The method may further include communicating the tagged input data element with the metadata classifications to a requesting computing device, via a communication device coupled to the processor to process the tagged input data element.

In one aspect, there is provided a machine learning model for metadata classification and labelling comprising: a multi-task learning model comprising: an input layer for receiving a first textual input characterizing one aspect of metadata for an input data element; and receiving a second textual input characterizing another aspect of metadata for the input data element; an embedding layer of the input layer, for embedding the first and second textual inputs separately and independently to a format suitable for long short term memory (LSTM) neural networks and each provided to a separate LSTM model in the input layer to generate a first and second output of the input layer respectively; a shared layer for receiving the first and second output of the input layer from each LSTM and concatenating the outputs to form a concatenated output, the shared layer subsequently applying hard parameter sharing for sharing model parameters including hidden layers across all tasks; and, a task specific layer for receiving the concatenated output including the hard parameter sharing to learn parameters specific to each task and classifying the concatenated output into at least one of a possible set of tasks corresponding to separate metadata classifications using a set of simultaneously trained classifiers, the multi-task learning model being a single model trained to simultaneously learn, during a training phase, multiple classification tasks corresponding to different metadata classifications.

In one aspect, there is provided a computer-implemented method for metadata classification and labelling of data elements using machine learning, the method comprising: receiving a first textual input, via an input layer of a multi-task learning model of a metadata classifier, for characterizing one aspect of metadata for an input data element; and receiving a second textual input characterizing another aspect of metadata for the input data element; embedding, via an embedding layer of the input layer, the first and second textual inputs separately and independently to a format suitable for long short term memory (LSTM) neural networks; providing each embedding to a separate LSTM model in the input layer to generate a first and second output of the input layer respectively; receiving the first and second output of the input layer from each LSTM model, at a shared layer coupled to the input layer, and concatenating the outputs to form a concatenated output, the shared layer subsequently applying hard parameter sharing for sharing model parameters including hidden layers across all tasks; receiving, at a task specific layer coupled to the shared layer, the concatenated output for including the hard parameter sharing to learn parameters specific to each task and classifying, at the task specific layer, the concatenated output into at least one of a possible set of tasks corresponding to separate metadata classifications using a set of simultaneously trained classifiers, the multi-task learning model being a single model trained to simultaneously learn, during a training phase, multiple classification tasks corresponding to different metadata classifications; automatically tagging the input data element with the metadata classifications; and communicating the tagged input data element with the metadata classifications to a requesting computing device, via a communication device coupled to the metadata classifier to process the tagged input data element.

In one aspect, the first textual input comprises: a business name field and a description field for the input data element, and the second textual input comprises: a malicious code field and a technical name field for the input data element.

In one aspect, the method comprises converting metadata fields for data elements into a recognizable format for the multi-task learning model via a sequence to sequence deep learning model, the sequence to sequence model having an encoder layer, an attention layer and a decoder layer for receiving the data elements as a sequence containing textual input representing a first domain including a name with acronyms and translating to a second domain including an understandable text for each data element, the understandable text provided as input to the multi-task learning model for further processing as a further aspect of the metadata.

In one aspect, the sequence to sequence deep learning model further applies long short term memory as the encoder and the decoder layers.

In one aspect, the method comprises receiving outputs from each task sublayer of a plurality of task sublayers providing multitask classifiers comprised in the task specific layer to determine an indication of a likelihood of an input to the task specific layer corresponding to one of the task sublayers, the outputs provided to a root mean square propagation in the optimization layer for increasing a learning rate for the task specific layer.

In one aspect, the multi-task learning model performs deep multi-task learning and comprises an input layer, a hidden layer and an output layer, each node in the output layer associated with a particular task of a set of tasks and sharing common features therebetween for optimization of the multi-task learning.

In one aspect, the method further includes applying, via the task specific layer, a binary threshold to at least some output nodes to determine a likelihood of whether input to the task specific layer falls within the particular task for the output layer to provide the metadata classification.

In one aspect, the method further includes applying via the task specific layer a soft max threshold to at least some output nodes to determine a likelihood of whether input to the task specific layer falls within the particular task associated with one of the output nodes.

In one aspect, the method further comprises: detecting a trigger event prior to performing the metadata classifications and automatically tagging the input data element, the trigger event including receiving an input, at the requesting computing device to initiate migration of the input data element to a computing cloud.

Other embodiments of this aspect include corresponding computer systems, apparatus, and computer programs recorded on one or more computer storage devices, each configured to perform the actions of the methods.

A non-transitory computer readable medium having stored thereon computer program code that is executable by a processor and that, when executed by the processor, causes the processor to perform the method of any of the foregoing aspects or suitable combinations thereof.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

These and other features of the disclosure will become more apparent from the following description in which reference is made to the appended drawings wherein:

FIG. 1A illustrates a schematic diagram of an example computerized metadata classifier communicating in a networked computing environment with data warehouses and data sources, in accordance with one embodiment of the disclosure.

FIG. 1B illustrates a schematic diagram of an example computerized neural network system including a sequence to sequence model for neural machine translation of sequences, for use with the metadata classifier of FIG. 1A, in accordance with one embodiment of the disclosure.

FIG. 2 is a diagram illustrating portions of an exemplary computing device implementing the metadata classifier of FIG. 1A and the neural network system of FIG. 1B, in accordance with one embodiment of the disclosure.

FIG. 3 is a schematic diagram illustrating example operation of the encoder of the neural network system of FIG. 1B, in accordance with one embodiment of the disclosure.

FIG. 4 is a schematic diagram illustrating different operations of a single task learning model and a multitask learning model, in accordance with one embodiment of the disclosure.

FIG. 5 is an example of data fields of an input data element processed by the computing environment of FIG. 1A and the generated labelled metadata classification in accordance with one embodiment of the disclosure.

FIG. 6 is an example output of experimental results for testing the machine learning models of FIG. 1A, in accordance with one embodiment of the disclosure.

FIG. 7 is a flowchart illustrating example operations of a computing device, in accordance with one or more examples of the present disclosure.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

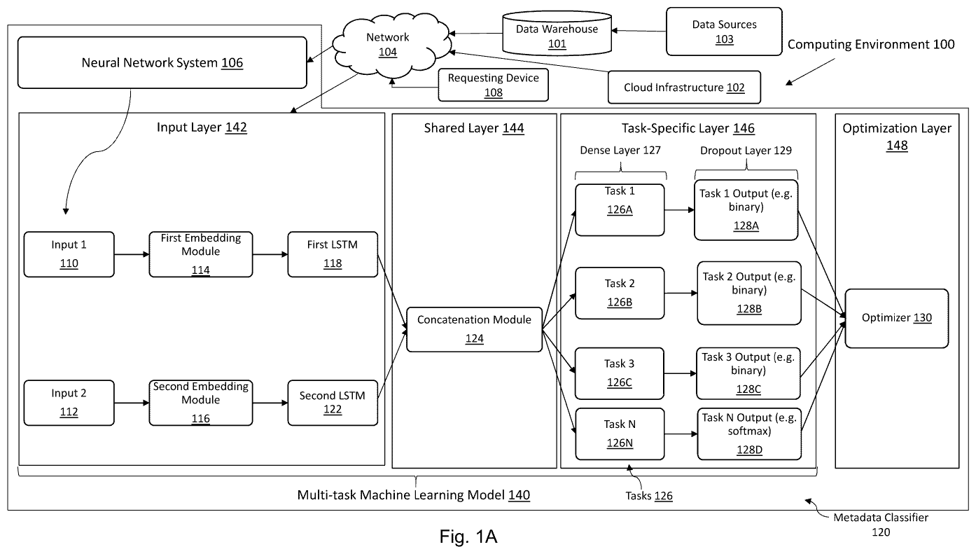

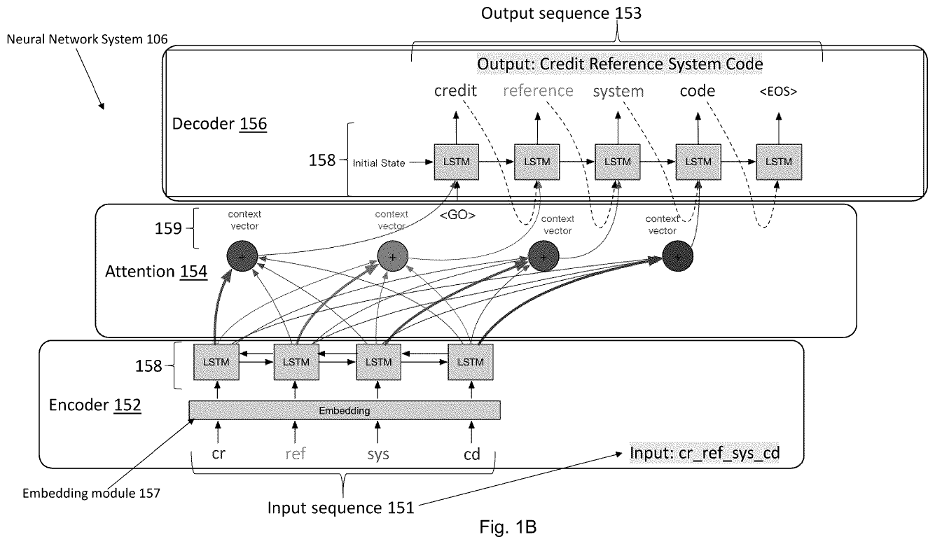

FIG. 1A illustrates an exemplary computing environment 100. In one aspect, the computing environment 100 may include one or more data warehouses 101 communicating with data sources 103, a cloud infrastructure 102, a requesting device 108, a computer-implemented metadata classifier 120, and a communication network 104 connecting one or more of the computing components and device of the computing environment 100. In one aspect, the metadata classifier 120 may be triggered to perform metadata classification via a request or a query either directly or indirectly from one or more requesting device(s) 108, such as for compatibility and data security compliance with migration of data to the cloud infrastructure 102. Alternatively, the metadata classifier 120, may be configured to perform metadata classification as described herein as being triggered automatically and/or semi-automatically (e.g. via user input on a requesting device 108).

The requesting device 108 can include, but not limited to, a personal computer, a laptop computer, a tablet computer, a tablet computer, a notebook computer, a handheld computer, a personal digital assistant, a portable navigation device, a mobile phone, a wearable device, a smart phone, third party portals, or any additional or alternate computing device that is configured to generate queries for metadata classification and/or receive updated data that includes metadata classification generated by the metadata classifier 120 and/or provide updated data having assigned metadata classification to the cloud infrastructure 102, and may be operable to transmit and receive data across the communication network 104.

The metadata classifier 120 is configured to receive data input from one or more electronic data warehouse(s) 101 and associated data sources 103. Such communication may occur across one or more communication networks 104. In at least some aspects, the computer-implemented metadata classifier 120 is a computer-implemented natural language processing (NLP) based machine learning model and system built based on a complex architecture of deep neural networks as provided by the multi-task machine learning model 140 (also referred to as a multi-task learning model herein).

This computerized metadata classifier 120 is a computer-implemented system including various computing modules and data stores for predicting in a live executing environment and in a dynamic and real-time manner, enterprise data warehouse metadata labels for data elements (e.g. associated with electronic resources, applications, workloads, tasks, etc.). Such metadata labels may be used for electronic management, including cloud migration, of electronic enterprise data warehouses such as data warehouse 101 (e.g. having associated networked servers and computing systems).

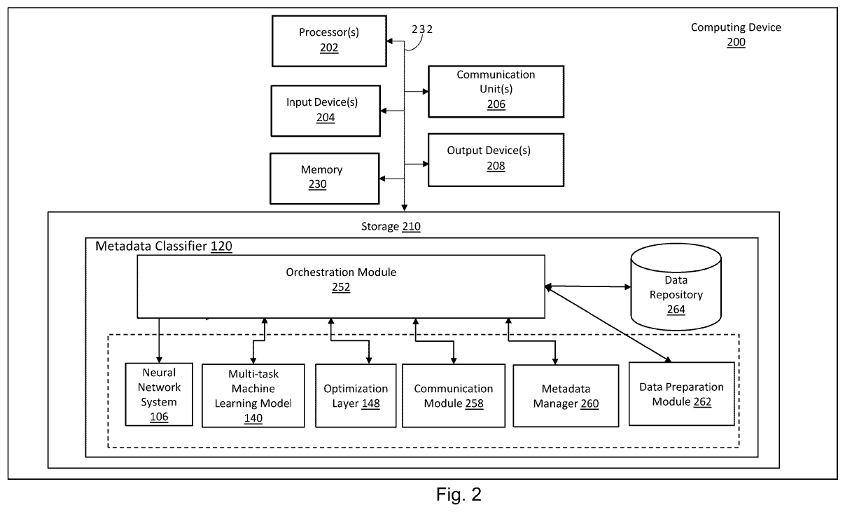

Generally, and in at least some aspects, the metadata classifier 120 applies the natural language processing and deep artificial neural networks shown in FIGS. 1A, 1B and 2 to automatically predict and tag classification metadata labels across a large number of data elements (e.g. hundreds of thousands of data elements) that are hosted in data warehouses, such as data warehouse 101 and associated servers such as to support data management, data security compliance and data governance, etc. Such metadata labels, once generated by the computing environment 100 according to the disclosed methods herein, may be communicated back to the data warehouses 101 to store and/or manage and/or communicate the metadata labels (e.g. across a communication network, not shown) and/or to additional computing devices, such as to requesting device(s) 108 and/or cloud infrastructure 102 across a network for determining compliance or adhere or compatibility of the metadata labels, and thereby the underlying data, with defined requirements for the data (e.g. such as needed for cloud migration to the cloud infrastructure 102) for performing additional validation and/or formatting and/or compliance actions thereon. Simply put, in one aspect, compliance of the generated metadata labels with defined cloud migration requirements for the cloud infrastructure 102, may trigger the computing device 200 shown in FIG. 2 implementing the metadata classifier 120 to initiate data migration of the underlying data being examined to the cloud infrastructure 102 across the network 104.

Thus, accurate defining of such metadata labels may be utilized for migration of data to the cloud, e.g. the cloud infrastructure 102, and validating the predicted and tagged metadata labels to ensure compatibility and data security compliance for the cloud migration. Such validation may additionally be performed by one or more of the additional computing modules of the metadata classifier 120, such as the metadata manager 260 of FIG. 2 in communication via a communication module 258 with the multi-task machine learning model 140 and the neural network system 106 and other computing modules of the computing device 200 for implementing the metadata classifier 120. The metadata classifier 120 and the neural network system 106 are computer-implemented systems which implement the computerized functionality described in the disclosure herein for use by the computing device 200.

In particular, this specification describes exemplary computer-implemented systems, apparatus, and processes that, among other things provide an improved computerized metadata classifier 120 using enhanced computerized neural network architectures (e.g. deep neural networks and natural language processing) for machine learning based classification to discover and predict multi-dimensional task classifications of large amounts of data such as from enterprise data warehouse(s) 101. Notably, by using improved natural language processing techniques and deep learning processes to customize the metadata classifier 120 as described herein, to accurately and proactively predict and tag or label multi-dimensional metadata task classification data for the underlying transaction data specific to the entity such as to improve accuracy of prediction, discover hidden insights, process large amounts of electronic data and reduce time to insight. While transaction data examples such as account data, credit card data, financial entity data, security data and/or authentication data, etc. may be utilized throughout the present disclosure, it should be understood that the present techniques and methods are not so limited as the present techniques may be utilized to determine metadata classification task data in numerous types of computing contexts.

As will be understood, an enterprise data warehouse (EDW) shown as data warehouse 101 is a centralized database, repository, or a collection of electronic databases, that stores, manages and centralizes an entity's information from multiple data sources 103 and corresponding applications, and makes it available for analytics and use across the entity in a networked environment. The enterprise data warehouse 101 may also be referred to as a relational data warehouse containing data, such as information about electronic transactions, customers or clients of an entity and associated data relating to the customers or clients for further analytics and manipulation.

The metadata classifier 120 is configured to harvest, ingest, extract, consolidate, receive, load and/or otherwise pull input data from one or more enterprise data warehouses 101 and associated data sources 103, including computing servers, databases and respective computers (not shown) either directly or across a communication network 104 such as via a requesting device 108, for automatically generating, and predicting metadata labels such as enterprise data warehouse metadata labels and tagging same to the respective data for subsequent action. Subsequent action may include, in some aspects, further determination by the metadata classifier 120 (e.g. metadata manager 260) of whether the classification metadata labels imply the underlying data is in compliance for cloud migration (e.g. via the cloud infrastructure 102) and/or meet data security requirements and/or privacy requirements for the computing environment which the requesting device 108 operates and/or connected devices.

Such input data may be further manipulated, transformed and/or normalized by the metadata classifier 120 (e.g. via a data preparation module 262 shown in FIG. 2) prior to metadata analysis via the neural network system 106 and/or deep multi-task learning model 140. Each data warehouse 101, may in turn, collect, integrate, manage and/or store data from a plurality of different electronic data sources 103 such as operational data sources, internal or external databases, IoT devices, social media websites, spreadsheets, flat files, applications, e-commerce sources, web services, etc.

### Metadata

In some embodiments, the metadata and associated fields processed by the computing environment 100 relate to electronic information that identifies and characterizes the underlying data and its various attributes, features or aspects (e.g. the classification name of the metadata and associated information, etc.). In some cases, the metadata may introduce jargon text or text understandable by a particular domain but not others (e.g. business jargon, or abbreviations, etc.). The metadata may include descriptive information to understand, locate, search and control or manage the content of the data for which it relates. In some embodiments, the metadata labels provided by the computing environment 100 relate to electronic data security and data privacy metadata and may also indicate data security risks posed by the data. In some embodiments, the metadata labels or fields identify the type of data and includes information of whether defined data security standards and/or data privacy standards are met within the data (e.g. labelled metadata may define which data security standards and/or data privacy standard are present in the data). The data security standards may include a set of requirements for the data to ensure that transaction information (e.g. credit card information) maintains a secure environment. The metadata may include additional information that identifies transaction data information, including computing devices associated with the transaction.

Generally, in at least some embodiments, identifying such metadata is important for the computing environment 100 in ensuring data compliance with network, data security and/or data privacy requirements of a particular computing environment which the data resides or will be communicated in such as the data warehouse 101 and/or the cloud infrastructure 102, or other computing devices and systems. Additionally, discovering the metadata, tagging it to the data and ensuring compliance of the metadata to defined requirements such as data security and data compliance standards which are needed and defined for cloud migration of the data such as cloud, e.g. Azure™ migration. The metadata labels, once identified and classified by the metadata classifier 120 of FIGS. 1A and 2, may be applied by subsequent computing components (e.g. see metadata manager 260 of the computing device 200) to assess compliance with desired electronic data security, network security and data privacy requirements. For example, assessment of the security protection of the data for storage, processing and/or transmission of the data. In one example, every entity which processes electronic payments such as credit card payments must have its underlying data (e.g. transaction data) comply with data security requirement of PCI (payment card industry). This ensures information technology security, including data security for data and information transacted over the entity's computing environment, such as customer information and related merchant or purchaser information.

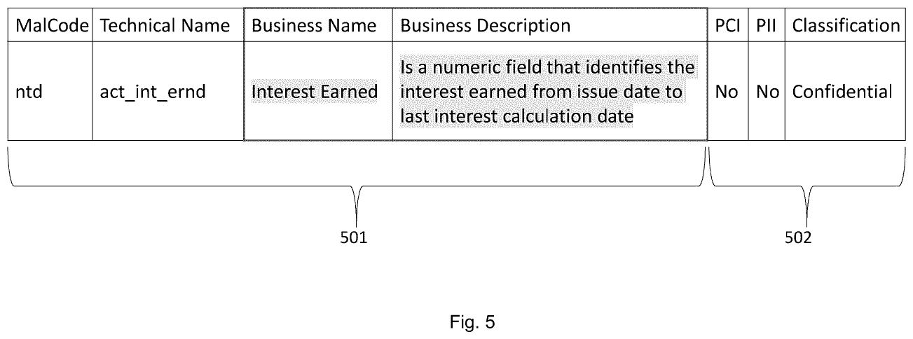

An example of the metadata classification labels and values generated from input data fields is shown in FIG. 5.

The metadata classifier 120 shown in FIG. 1A comprises a deep multi-task machine learning model 140, a neural network system 106 for performing machine translation of sequences and an optimization layer 148. As discussed herein, the metadata classifier 120 receives input data and fields from one or more data warehouses 101, associated data sources 103 and in at least some aspects, additional input from the neural network system 106 which performs sequence transduction such as performing machine translation to convert sequences into a recognizable format for processing.

### Neural Network System 106

The neural network system 106 may perform machine learning translation to convert one or more textual input sequences of items (e.g. words, letters, sentences, abbreviations, combinations of letters and numbers, sequence of text, technical textual terms, or combinations of the above, etc.) from the data warehouse 101 and output another sequence of items, specifically formatted and/or translated for use of other computing devices such as the multi-task machine learning model 140. For example, in at least some aspects, the neural network system 106 implements a customized sequence to sequence model for neural machine translation, such as to convert incomprehensible and/or undecipherable sequence of text (e.g. word abbreviations or entity specific technical names or a sequence that may be understood by entity devices but not understood by all computing systems) from a first domain language to a second domain language (e.g. that is understood by the machine learning model 140 such as common words or sentences). Additional exemplary computing modules of the metadata classifier 120 and/or neural network system 106 including additional data stores of the metadata classifier 120 are illustrated in FIGS. 1B and 2.

Referring to FIGS. 1A and 1B, the neural network system 106 may be configured to perform neural machine translation using a customized sequence to sequence model approach, shown in FIG. 1B which is an attention based model with context vectors. The neural network system 106 is configured to translate or convert an input sequence detected in metadata of the input data (e.g. sequence of text, words or letters such as technical name, or other account or transaction identifiers) into a second output sequence to be further processed and analyzed by the deep multitask machine learning model 140.

Referring to FIG. 1B, exemplary computing components of the neural network system 106 are shown in further detail processing an example input and output sequence of text. The neural network system 106 is a computerized sequence to sequence model using attention based context vector operations and performing natural language processing as shown in schematic block diagram in FIG. 1B. In the example illustrated in FIG. 1B, the neural network system 106 takes an input sequence 151 (e.g. provided in a first domain language such as technical name for the metadata) and decodes or converts it to an output sequence 153 of text (e.g. provided in a second domain language understandable by the subsequent machine learning model). In the example of FIG. 1B, the neural network system 106 produces the missing “Business Name” metadata field from the “Technical Name” provided in the input sequence 151 for each data element processed. The neural network system 106 may be a particular customized sequence to sequence model comprising an encoder 152, attention 154 layer, and a decoder 156. The encoder 152 and decoder 156 are a special class of recurrent neural network (RNN) architectures solving complex language problems including machine Translation, Question Answering, creating Chatbots, Text Summarization, etc. In this case, the sequence to sequence model implemented by the neural network system 106 is shown in FIG. 1B and takes as input sequence 151, a sequence of metadata which may contain the technical fields of data elements in one domain language and converts, using natural language processing via the encoder 152, the attention 154 layer and the decoder 156 to decode to a second sequence of text in a second domain language, e.g. business name which are understandable by other systems, such as requesting device 108 and/or cloud infrastructure 102 and/or the multi-task machine learning model 140.

By determining the missing metadata fields and converting them into understandable format for the machine learning model 140, this allows better operation and accuracy of the machine learning model 140 such as to better standardize the inputs for such a model and allow improved task based classification. Notably, the additional decoded information provided by the neural network system 106 (e.g. converting an input sequence of text to an output sequence of text using an attention based sequence to sequence context model) is used to further characterize additional fields of the metadata useful for the multi-dimensional task classification performed by the task specific layer 146.

Referring again to the neural network system 106, it provides a sequence to sequence model, being a particular class of a recurrent neural network (RNN) model, with attention 154 layer. In at least some aspects, the neural network system 106 is an RNN combination with Long Short Term Memory (LSTM). Put another way, the encoder 152 and the decoder 156 are both RNNs, such that in a time step one of the RNNs does the processing and updates its output or hidden state vector based on the input and prior inputs seen. The neural network system 106 is a deep learning model configured to take an input in the form of a sequence of text, e.g. sequence of words shown as input sequence 151 and generate an output in the form of another sequence of words, such as the output sequence 153.

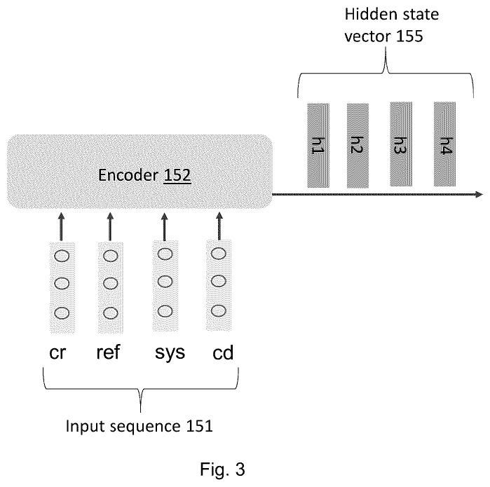

FIG. 3 illustrates a schematic block diagram of the encoder 152 module of the neural network system 106 of FIGS. 1A, 1B and 2, in an example operation. The encoder 152 receives an input sequence 151, in the form of a series of words or a sentence or other textual format. The encoder 152, applies every single textual component, e.g. word of a sentence to transform it into a vector via an embedding module 157 and then applies the vector to an LSTM 158 module (see FIG. 1B) to generate a set of hidden state 155 vectors. Each hidden state vector 155 vector is then passed onto the attention 154 layer, whereby as shown in FIG. 1B, the hidden state 155 vectors are assigned a score and are added (with their score weighting) to obtain the set of contexts or the context vectors 159. Put another way, the attention 154 layer receives a sequence of vectors (hidden states shown as the hidden state vector 155) as input and generates an attention vector. In this attention 154 layer, the weighted average is performed to obtain a single context vector 159. This layer helps the decoder 156 to focus on the important parts of the input sequence 151 and reduce the irrelevant ones (e.g. irrelevant components).

The context vector 159 may provide a summary of the input sequence 151 such that it summarizes the information in the input sequence 151 in a context vector 159 in the attention 154 layer. In at least some aspects, the context vector 159 is computed by the neural network system 106 as a weighted sum of the hidden state vector 155 shown in FIG. 3. The decoder 156 is then initialized with the context vector 159 as input and applies a set of LSTM 158 modules to generate the output using auto regression (consuming previous output) to generate the output sequence 153. In at least some aspects, the auto regression performed by the decoder 156 generates the output sequence 153, an element at a time and is facilitated by the context vectors 159 generated using the encoder 152 and the attention 154.

In at least one aspect, the decoder is a recurrent neural network (RNN) where in each time step, context vector 159 from attention 154 layer is concatenated with decoder 156 hidden state. The generated vector is passed through a feedforward neural network as illustrated in the decoder 156 and the output word, shown as output sequence 153 is generated at each time step.

As illustrated in FIG. 1B, the encoder 152 and the decoder 156 may have similar structure of modules utilizing RNN and LSTM.

Put another way, the attention 154 layer enhances some parts of the input data while minimizing other parts and facilitates the neural network system 106 devoting more focus or attention to small but important parts of the input data, e.g. input sequence 151. This neural network system 106 presents an advantage in metadata labelling as it improves understandability, accuracy and operation of a subsequent metadata classification system, such as the multi-task machine learning model 140 which focuses on using deep multitask learning for predicting and tagging metadata labels. Without performing the particular neural network system 106 transduction of sequence into a desired format for the output sequence, the subsequent metadata task classification may be inaccurate if the data fields contain unrecognizable text sequences.

In the example shown in FIG. 1B, an example input sequence 151 including text such as words, letters, symbols, and combinations thereof such as but not limited to: acronyms, undecipherable letters or portions of words, uninterpretable or incomplete words, is input as a sequence and once processed by the neural network system 106 is converted by the decoder 156 into a format that is understandable and interpretable by subsequent computing devices, such as example output: “credit reference system code” being output sequence 153 from processing example input sequence 151 shown as example input: “cr_ref_sys_cd”.

Thus, as described, one example application of the neural network system 106 architecture applying sequence to sequence translation is to translate an input sequence of textual content having acronyms or abbreviations and/or symbols into a second output sequence in a second domain language, e.g. English words. As shown, in FIG. 1B, this is performed by applying a particular machine learning model utilizing sequence to sequence learning using the architecture of FIG. 1B.

In an embodiment, the metadata classifier 120 may be provided on a computing device, such the computing device 200 which may include a computing device having one or more tangible, non-transitory memories that store data and/or software instructions, and one or more processors, e.g., processor 202, configured to execute the software instructions for implementing various modules of the metadata classifier 120. The one or more tangible, non-transitory memories may, in some aspects, store software applications, application modules, and other elements of code executable by the one or more processors, e.g., within storage 210 containing application and/or data modules.

Metadata classifier 120 utilizes neural network deep learning and natural language processing computing modules, illustrated in FIGS. 1A, 1B and 2 to perform computing operations (e.g. via one or more computing modules shown in FIG. 2 including processor 202, storage 210 and/or memory 230) that detect one or more of the elements of metadata within the elements of input data. The metadata classifier 120 may further be configured via its various computing modules shown in FIGS. 1A, 1B and 2 to obtain, from the elements of metadata, additional or alternative elements of information customer data, payment data, transaction data, or vendor data, as described herein. The metadata once discovered and tagged by the metadata classifier 120 shown in FIGS. 1A, 1B and 2 may be stored in one or more metadata repositories such as held within the data warehouse 101 and/or data repository 264.

### Multi-Task Machine Learning Model 140

Referring to FIG. 1A, the multi-task machine learning model 140 comprises an input layer 142, a shared layer 144, a task specific layer 146 and in some optional aspects, an optimization layer 148. In other aspects, the optimization layer 148 may be a separate computing entity or computing modules as part of the metadata classifier 120.

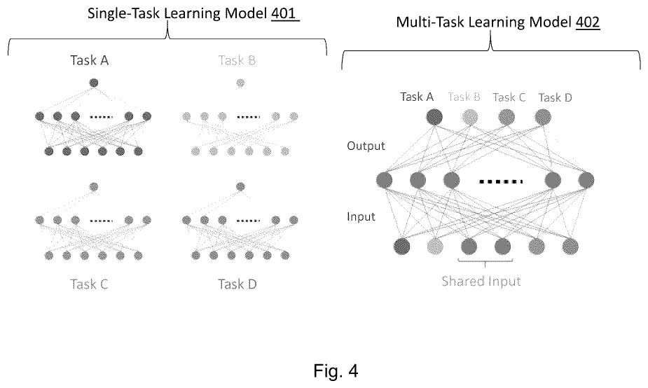

The disclosed architecture provides a single multitask learning classification model which is able to predict simultaneously multiple metadata classifications using a multitask learning model as shown in the multi-task machine learning model 140. That is, utilizing two or more separate classification models to predict multiple classification tasks in which the output of the first model (e.g. prediction classification task labels) is ingested into the second model as the input to predict the second classification task label is tedious, cumbersome and requires a lot of computing resources to train and built multiple models. An example of this configuration is shown in FIG. 4 at the single task learning model 401. The current proposed machine learning model 140, also shown in generality in a portion of FIG. 4 as a multi-task learning model 402 is a more sophisticated machine learning model architecture which leads to improved accuracy of multi-classification detection and faster detection while utilizing reduced computing resources and bandwidth, in at least some aspects by allowing the classification tasks to learn from one another during the task classification stage (e.g. hard parameter sharing). Put another way, using a single multi-task model and training a multi-task machine learning model 140 (or shown as multi-task learning model 402) simultaneously to predict several related task classifications (e.g. task 1 126A, task 2 126B, task 3 126C, . . . task N 126N) while considering common features and optimization of the overall classification will result in improved performance and accuracy over a number of single models which only predict single task objectives. Additionally, in at least some aspects, the multi-task machine learning model 140 further improves its classification task performance by converting input metadata that is undecipherable into a desired domain language for improved understandability and extraction of information by the multi-task machine learning model 140.

Generally, the multi-task machine learning model 140 is a machine learning model configured, via its multiple layers, such that data from multiple tasks are used by the model to train the model at the same time for multiple metadata classification tasks, by using shared information uncovered between the tasks (e.g. sharing hidden data uncovered by the model from one task to another related task in the tasks 126). This uncovers related information amongst a group of connected tasks in the model, such as shown in the task-specific layer 146. An example high-level schematic implementation of the multi-task machine learning model 140 with the sharing of hidden information is shown in FIG. 4 as the example multi-task learning model 402.

The layers shown in the multi-task machine learning model 140 may include an input layer 142, a shared layer 144, a task-specific layer 146 and an optimization layer 148. The multi-task machine learning model 140 is an artificial neural network where each layer in the network model's architecture takes information from the previous layer (e.g. the input layer 142) and passes it on the subsequent layer (e.g. the shared layer 144). Each of the layers may comprise neurons or nodes and links there between, such that each layer applies a transformation on each element on the input with an activation function. Generally, the layers of the machine learning model 140 cooperate together to transform the input data, which may be textual input (e.g. input metadata including business name to which the metadata relates) to information that can be better understood by the computer, such as the computing device 200, such as extracting and labelling one or more tasks 126 associated with the input metadata processed by the input layer 142.

In one example implementation, the multi-task machine learning model 140 shown in FIGS. 1A and 2 classifies and tags the following metadata security labels on each data field simultaneously. The following are examples of metadata classification task outputs or labels provided from the task-specific layer 146 of the multitask machine learning model 140: PCI (Payment Card Industry); PII (Personally Identifiable Information); Data Security Classification (Public/Internal/Confidential/Restricted/Critical); Data Treatment Classification.

As noted earlier, preferably at least one input of the input layer 142 is obtained or extracted from a sequence to sequence model shown as the neural network system 106 which converts a first text, e.g. technical name to a second text output, e.g. a business name and provides same to the input layer 142, e.g. as input 1 110.

In implementation, referring to FIGS. 1A, 1B and 2, the computing device 200 of FIG. 2 comprising the neural network system 106 and the multi-task machine learning model 140, may be configured to trigger the operation of the neural network system 106 upon receiving a metadata task classification request from a requesting device 108 to translate the input metadata into a second format (e.g. determining the business name metadata from the technical name).

### Input Layer 142

The input layer 142 shown in FIG. 1A is then configured to receive multiple textual inputs and components (or data fields) relating to the metadata features, attributes, or categories. For example, input 1 110 may relate to a BN (business name) and BD (business description) for the underlying data. The business description metadata may further be helpful in predicting task classifications from the textual input. In this example, the second input, input 2 112, may include MC (malcode) and technical name. The malcode metadata may provide indications regarding malicious code information. These are examples only and other types of metadata textual features may be applied as input to the input layer 142 for input 1 110 and input 2 112.

In the input layer 142, one or more received inputs (e.g. input 1 110, input 2 112) may be received in a textual format (e.g. words, sentences, etc. defining various defined features of the metadata). The first and second embedding modules 114 and 116 may be configured to convert each word or sentence into a numerical representation to perform word embedding. In some aspects, the embedding modules 114 and 116 may for example map each word to a vector such that words having similar meanings have similar representations in the vector space. First and second embedding modules 114 and 116 enable converting each word or text sequence into a fixed length vector of defined size, which allows easier representation of words with reduced dimensions. In at least some embodiments, the first and second embedding modules 114 and 116 function similarly and are applied to different inputs. In at least some aspects, the neural network system 106 is further advantageous to cooperate with the machine learning model 140 as it allows conversion of the input sequence of text from a format that is not understandable or interpretable by the model 140 into another understandable sequence of text which may be used by the first and second embedding modules 114 and 116 to understand context and meaning for the text and allow use with long short term memory or LSTM (e.g. via first and second LSTM modules 118 and 122) to perform natural language processing and conversion into vector format. Thus, in some aspects, the first and second embedding modules 114 and 116 are configured to generate an output such that input words or text (e.g. inputs 110 and 112) having a similar context have similar vector embedding. Thus, the output from the first and second embedding modules 114 and 116 are vector representations of the particular words input from the textual metadata input feature attributes, including input 1 110, and input 2 112. LSTM as performed by first and second LSTM modules 118 and 122 is a type of recurrent neural networks (RNN) which has feedback connections and is configured to process complete data streams and sequences of data. The first and second LSTM modules 118 and 122, may utilize a deep recurrent neural network (RNN) architecture and be configured in at least some aspects, to generate shared features for different classifiers. The first and second LSTM modules 118 and 122 may, in at least some aspects, receive different sequences of inputs over time and be configured separately and individually to handle missing features that are then concatenated in the shared layer 144 and all these features are the fed to the set of separate classifiers shown as task 1 126A, task 2 126B, task 3 126C, task N 126N (generally tasks 126) which are optimized at the same time to determine a category or classification information for the input sequence received or harvested at the input layer 142.

Put another way, the input 1 110 and input 2 112, may be tokenized versions of an original input string of data and may include in one example, account information and numerical data. In one aspect, the first and second embedding modules 114 and 116 are configured to map each value in an input array to a dense vector of a defined size so that they may be understood by the first and second LSTM modules 118 and 122. The first and second LSTM modules 118 and 122 (which may be configured similarly), are provided in a long short-term memory layer that helps improve gradient flow over long sequences during training. The multi-LSTM input layer 142 is thus configured to handle the input data with missing features in the shared layers 144.

In one example, the model is input with four features or fields of the metadata but other variations of the number of features may be envisaged. The input data provided as input to the input layer 142 may be representative of the privacy characteristics of the data, such as from privacy and compliance information extracted from the data and used to distinguish the classification tasks for the features that are usable.

### Shared Layer 144

Referring again to the multi-task machine learning model 140 of FIGS. 1A, and 2, the model is built based on the shared hidden layers (e.g. shared layer 144) between all tasks (e.g. tasks 126). The shared layer 144 is a common space for representing the parameters of all tasks (e.g. tasks 126) which allows the model to take advantage of similarities and overlaps between the tasks 126. Thus, in at least some aspects, the tasks 126 may be processed by the model in the shared layer 144 to determine the degree of overlap therebetween and those having a higher than a defined threshold. Thus, the model 140 is further configured to use the related task information determined via the shared layer 144 to help transfer the knowledge from relevant tasks to other tasks (e.g. tasks 126) and build a more general model. As shown in FIG. 1A, the shared layer 144, comprises a concatenation module 124 and such layer considers information from all inputs from the input layer 142 (both inputs should have the same size) and concatenates the features along a specified dimension.

The model 140 applies multi-task machine learning with hard parameter sharing method to classify multiple classification tasks. The model is trained using labelled data sets and simultaneously trained in the training phase for all tasks, thereby allowing the tasks 126 to learn from one another where they share hidden parameters (e.g. in the shared layer 144). The multi-task machine learning model 140 is trained simultaneously for detection and classification of all tasks.

The shared layer 144 is the layer where the hard parameter sharing is applied. Hard parameter sharing is a set of common layers that allows the model 140 to take advantage of task similarity. Using the information from related tasks 126 in the shared layers, the model 140 helps transfer the knowledge among relevant tasks (e.g. task 1 126A, task 2 126B, task 3 126C, . . . task N 126N) and build a more general model. This representation is then passed to task-specific layers for learning parameters centric to the task. By allowing the model 140 to learn multiple tasks simultaneously, it allows the model 140 to find a shared representation to capture all of the tasks 126. Put another way, the hard parameter sharing described herein allows the model 140 to learn a shared representation from all of the tasks, including primary and secondary tasks for which the model is trained and reduces risk of overfitting.

Put another way, the hard parameter sharing applied to the model 140 reduces risk of overfitting. Overfitting is when the computing machine learning model learns concepts from the noise or random data in the training data.

### Task Specific Layer 146

In the task-specific layer 146, the computing device 200 configures the model 140 to learn from multiple independent classifiers (e.g. shown as task 1 126A, task 2 126B, task 3 126C, task N 126 providing independent task classification) by adding additional task specific layers for each task to produce prediction for different tasks simultaneously and specifically based on task's features.

Both the task specific layers 146 and the common layers are trained using back propagation. This training process may include the computing device 200 when training the multi-task machine learning model 140, taking the error rate of forward propagation and feeding the loss or the error backwards through the network to allow the weights to be adjusted so the network machine learning model 140 can learn and fine-tune the weights of the nodes in the model 140. Each task (e.g. task 1 126A, task 2 126B, task 3 126C, . . . task N 126N) in the task-specific layer 146 is processed through two layers including a dense layer 127 and a dropout layer 129. The dense layer 127 is a regular densely-connected neural network layer that implements the operation: Output=Activation(dot(input, kernel)+bias) with Activation function=Relu. The ReLU activation or rectified linear activation function works by outputting the inputting directly if it a positive value and otherwise outputting zero. Conveniently, using ReLU activation function is helpful with convolutional layers and deep learning models as it yields better results. The dropout layer 129 is configured such that during the training, randomly sets input units to 0 with a frequency of rate at each step to prevent overfitting. Inputs not set to 0 are scaled up by 1/(1−rate) such that the sum over all inputs is unchanged.

For example, in the example implementation where the classification tasks 126 predicted relate to PCI, PII, SC and DT then the task 1 output 128A may provide PCI Output, the task 2 output 128B may provide PII Output, the task 3 output 128C may provide the SC Output, the task N output 128D may provide the DT output, etc.

Conveniently, in at least some aspects, the particularly configured multitask model 140 of FIGS. 1A and 2, once trained simultaneously for multiple tasks and configured using parameter sharing, reduces storage cost and training time as compared to models which consider a single task at a time, while improving accuracy of predictions. In at least further aspects, this may be further improved, by utilizing the neural network system 106 to cooperate with the multitask machine learning model 140 as described herein.

Referring to FIGS. 1A, 1B, and 2, during the training of the model 140, the same input is applied by the computing device 200 for all tasks in the multi-task machine learning model 140 to generate outputs for each specific task, via the task-specific layer 146. In the task-specific layer 146, the computing device 200 of FIG. 2 implementing the metadata classifier 120, is configured to associate weights to the loss function of each task, of the set of tasks 126. In multi-task learning of the model 140, the computing device 200 implementing the model 140 and the metadata classifier 120 optimizes multiple loss functions for tasks simultaneously using a weighted loss function to perform multi-objective optimization. The goal is to find a pareto optimal solution that achieves a balanced trade-off for all the optimized tasks (i.e. loss functions). This way, the computing device 200, is configured to generate a generalized model, such as the multi-tasks machine learning model 140 providing the metadata classifier 120 to satisfy the needs for multiple tasks at the same time. Advantageously, this helps save the training time for the computing device 200 as one neural network model, e.g. metadata classifier having a single multitask machine learning model, is trained for several classification tasks. Multi-task learning as provided by the multi-task machine learning model 140 of the metadata classifier once generated, also avoids overfitting and provides fast learning models by leveraging shared tasks' information as described herein with respect to FIGS. 1A and 2.

### Optimization Layer 148

Referring again to FIG. 1A, the outputs from the task specific layers indicating one or more task classifications (e.g. task 1 output 128A . . . task N output 128D) may then be fed into an optimization layer 148 coupled to the task-specific layer 146. The optimization layer 148 comprises an optimizer 130 and is a regular densely-connected neural network layer that implements the example optimization operation. Such optimization operation may include: Output=activation(dot(input, kernel)+bias) and Activation function=Sigmoid, Softmax. The softmax function outputs a vector that represents the probability distributions of a list of potential outcomes.

The optimizer 130 optimizes a loss function which a weighted sum of the loss functions for each task, e.g. where for some tasks PCI and PII, binary cross entropy loss function is used and for e.g. other tasks security classification (SC) and Data Treatment (DT), categorical cross entropy loss function is used:

$${min}_{θ} {\sum }_{i = 1}^{T} {w}_{i} {i}_{} ( θ , {i}_{} )$$

Following the classification via the task-specific layer 146, optimization methods may be applied via the optimization layer 148 having an optimizer 130 which include but not limited to: root mean square propagation (RMSprop), Multi-Layer Perceptron, Epoch, Batch-size, TensorBoard which optimize the neural network model and speed up the learning.

Referring now to FIG. 2, there is shown a schematic block diagram of an example computing device 200 with example computer components and modules that can be used to provide the metadata classifier 120 including the neural network system 106, the multi-task machine learning model 140 and in some aspects, an optimization layer 148 as shown in the computing environment 100 of FIG. 1A. The computing device 200 may be configured to perform the methods of multi-task machine learning for metadata classification and labelling as well as sequence to sequence conversions to assist the metadata classification of the multitask model, as per the computing methods, processes and computing architectures described herein.

The computing device 200 comprises one or more processors 202, one or more input devices 204, one or more communication units 206, one or more output devices 208 and a memory 230. Computing device 200 also includes one or more storage(s) 210 storing one or more computer modules such as an orchestration module 252 for managing and/or controlling operations of the modules in the storage 210 comprising a metadata classifier 120. The metadata classifier 120 may comprise a plurality of computing components as shown in FIG. 2 (and in FIGS. 1A, 1B). The metadata classifier 120 may comprise an orchestration module 252, a neural network system 106, a multi-task machine learning model 140, an optimization layer 148, a metadata manager 260, a data preparation module 262 and a data repository 264.

In at least some implementations, data generated and/or used by the modules in the storage 210 is stored within the data repository 264 to manage data stored and may contain data relating to the analysis and labelling of metadata classifications and model generations for the neural network models including the model 140 and/or the neural network system 106.

The neural network system 106, the multi-task machine learning model 140 and the optimization layer 148 may be trained, tested and generated via the processor(s) 202 and the orchestration module 252 utilizing training and testing data as described herein, which may be stored via the data repository 264.

The metadata manager 260 may be configured to communicate with other computing modules within the storage 210 and other computing devices, such as within the computing environment 100, including the requesting device 108, the data warehouse 101, the data sources 103, the cloud infrastructure 102 to receive a request for metadata labelling and trigger the operation of the processor 202 and/or orchestration module 252 to generate the neural network models, including the multi-task machine learning model 140 and the neural network system 106, which are a natural language processing based models, having unique architectures as shown in FIGS. 1A and 1B for automatically predicting and performing metadata classification labelling, using deep machine learning methods as described herein.

In one example implementation, one example workflow sequence of components in the computing device 200 may be the data preparation module 262 performing data cleaning and data augmentation of metadata related data received across the computing environment 100 (e.g. see FIG. 1A) such as to prepare the data for the metadata classifier 120. The metadata classifier 120 may then trigger the operation (e.g. via the orchestration module 252) of the neural network system 106 for implementing a sequence to sequence model conversion and translation applying an attention layer as shown in FIG. 1B. As described herein, the neural network system 106 may be a customized and particularly defined class of recurrent neural network architectures utilizing sequence to sequence models which may perform machine translation and in an example implementation, convert missing field names such as “Business names” from the “technical name” for each data element. The orchestration module 252 may then trigger operation of the multi-task machine learning model 140 for performing multi-task learning with hard parameter sharing optimization. In at least some embodiments described herein, the model 140 is a natural language processing machine learning model implementing a complex architecture of specialized deep neural networks and computing modules as shown in FIG. 1A configured to automatically generate and tag metadata labels by applying multitask learning from a large number of data elements hosted in the data warehouse 101, as received across the network 104 shown in FIG. 1A. In one example implementation, the multi-task machine learning model 140 classifies and tags metadata security labels on each data field simultaneously (e.g. via the task-specific layer 146) utilizing the methods described herein. One example of metadata security labels may include: PCI (Payment Card Industry); PII (Personally Identifiable Information); Data Security Classification (Public/Internal/Confidential/Restricted/Critical); and Data Treatment Classification.

Subsequently, the optimization layer 148 may perform additional optimization of the metadata labelling and classification. The metadata manager 260 may be triggered to track such labelling and communicate same back to one or more requesting devices, such as across computing environment 100 for subsequent action, including determination of whether the metadata classification meets predefined requirements for the cloud infrastructure 102 and migration of associated data to same. Such data classification labelling may further be used, in at least some aspects, by the metadata manager 260 and/or other computing devices in the computing environment 100 to retrieve predefined metadata security label requirements for data elements within the computing environment 100, such as from data repository 264 and determine whether cloud migration requirements are met or determine how data elements should be organized, formatted, and stored within electronic databases on the computing device 200 and other computing devices in the computing environment 100.

Communication channels 232 may couple each of the components including processor(s) 202, input device(s) 204, communication unit(s) 206, output device(s) 208, memory 230, storage device(s) 210, and the modules stored therein for inter-component communications, whether communicatively, physically and/or operatively. In some examples, communication channels 232 may include a system bus, a network connection, an inter-process communication data structure, or any other method for communicating data.

One or more processors 202 may implement functionality and/or execute instructions within the computing device 200. For example, processors 202 may be configured to receive instructions and/or data from storage devices 210 to execute the functionality of the modules shown in FIG. 2, among others (e.g. operating system, applications, etc.). Computing device 200 may store data or metadata information relating to the generation, analysis and communication of neural network model generation and metadata classification for harvested content and input data (e.g. as received across network 104) from computing devices and response thereto of the predicted metadata classifications to storage devices 210 and/or associated computing devices, across communication network 104. Some of the functionality is described further herein below.

One or more communication units 206 may communicate with external computing devices (e.g. computing devices shown in FIG. 1A) via one or more networks (e.g. network 104) by transmitting and/or receiving network signals on the one or more networks. The communication units 206 may include various antennae and/or network interface cards, etc. for wireless and/or wired communications.

Input devices 204 and output devices 208 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. communication channels 232).

The one or more storage devices 210 may store instructions and/or data for processing during operation of the computing device 200. The one or more storage devices 210 may take different forms and/or configurations, for example, as short-term memory or long-term memory. Storage devices 210 may be configured for short-term storage of information as volatile memory, which does not retain stored contents when power is removed. Volatile memory examples include random access memory (RAM), dynamic random access memory (DRAM), static random access memory (SRAM), etc. Storage devices 210, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

The computing device 200 may include additional computing modules or data stores in various embodiments. Additional modules, data stores and devices that may be included in various embodiments may not be shown in FIG. 2 to avoid undue complexity of the description.

Communications unit 206 may be configured to communicate various data between components of the computing device 200, its internal modules shown in the storage 210 and other computing devices shown in FIGS. 1A, and 1B.

The orchestration module 252 may provide a centralized control of the operations of the modules (e.g. the neural network system 106, the multi-task machine learning model 140, the optimization layer 148, communication module 258, metadata manager 260, and data preparation module 262).

The orchestration module 252 may thus be configured to monitor the operations of the modules in the storage 210, route traffic and data as needed to perform the operations described herein, adjust the training and model generation operations of the machine learning modules (e.g. the neural network system 106 performing sequence to sequence model conversion with attention layer and the multi-task machine learning model 140 applying convolutional neural network and a customized architecture shown in FIG. 1A), such as in response to feedback received from other modules of the computing environment 100 regarding the performance of the models for classification and such as to deal with data drift and to achieve optimal classification generation.

In at least some embodiments of FIGS. 1A-1B and 2, the computing device 200 is configured, via the orchestration module 252, to automatically and dynamically generate and tag metadata classification labels from data elements received at the computing device 200 for metadata labelling (e.g. across communication network 104 from computing devices such as triggered by requesting device 108) such that the data elements may be retrieved from data warehouses 101.

In another embodiment, the computing device 200 will generate an automated metadata label for the harvested data elements for tagging to the data fields of the data elements harvested from the data warehouse 101 as per the methods described herein. In some aspects, the computing device 200 may present the metadata labels on a user interface of the computing device or trigger the generation of the metadata labels for the data elements on a user interface associated with the requesting device 108 for subsequent interaction. In other aspects, the automated metadata labels once generated via the metadata classifier 120 may be reviewed and processed by the metadata manager 260 to determine compliance of the metadata security labels automatically determined from the multi-task machine learning model 140 such as to determine compliance with security and data migration requirements of the computing environment 100, including defined data migration standards for the cloud infrastructure 102.

It is understood that operations may not fall exactly within the modules and/or models of FIG. 2 such that one module and/or model may assist with the functionality of another.

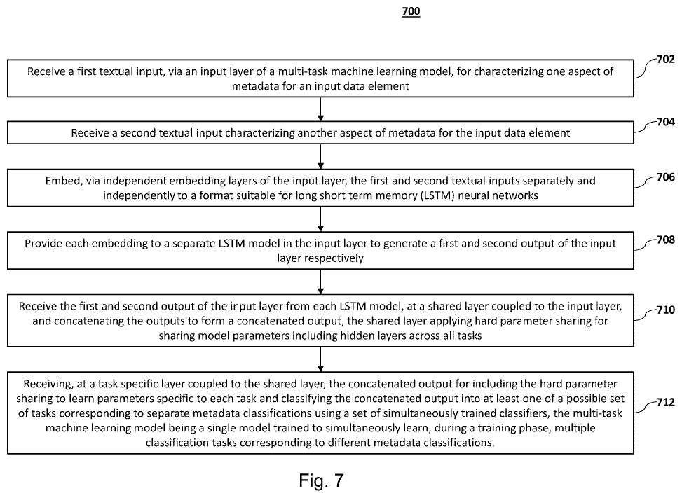

Referring to FIG. 7 shown is an example flow of operations 700 illustrating a method of operation for the computing device 200 of FIG. 2 implementing the metadata classification via the multi-task machine learning model 140 and the neural network system 106 of FIGS. 1A and 1B.

As described earlier, the computing device 200 may comprise at least a processor configured to communicate with a plurality of external computing devices in the computing environment 100. In at least some implementations, the computing device 200 receives input including harvested content, such as thousands of data elements from data warehouse 101 collected across the networked computer environment 100. The harvested content of data elements is used by the computing device 200 to automatically and dynamically predict, e.g. using a natural language processing multi-task machine learning model utilizing deep learning and a sequence to sequence model based on recurrent neural networks, at least one metadata label in response to the enterprise data warehouse content comprising textual content such as relating to privacy and security features of the underlying data.

The computing device 200 stores instructions (stored in a non-transient storage device), which when executed by the processor, configure the computing device 200 to perform computing operations such as operations 700.

At operation 702 and operation 704, first and second textual inputs representative of different data element features or metadata fields of input data elements which may be harvested from enterprise data warehouses are received at an input layer of the multi-task machine learning model 140 for processing by the metadata classifier 120. For example, computing device 200 may extract a set of pre-defined data element fields relating to data security, data privacy, data treatment, data identification, transaction identification, etc. across a network 104 shown in FIG. 1A from enterprise data warehouse 101 and associated data sources 103, such as in response to a trigger request received from a requesting device 108 across the communication network 104 to determine metadata classification labels for the data and tag same. As noted earlier, such metadata labels once tagged may be used by the computing device 200 to determine compliance with computing network requirements of the computing environment 100 such as to determine compliance with pre-defined data security and/or data treatment and/or data privacy, etc. requirements of a cloud infrastructure 102 to determine whether data migration of the data elements considered may be possible to cloud.

An example data element harvested and received at the multi-task machine learning model is shown as example data 501 in FIG. 1 having a plurality of data fields, including technical name, business name, business description, malicious code, etc. Other data fields may be envisaged. As noted, the input data fields may be split by the computing device 200 into different textual inputs to be fed into the input layer 142, as separate inputs, e.g. input 1 110 and input 2 112 representing different features of the input data elements.

At operation 706, operations of the computing device 200 configure the computing device to embed each of the first and second textual inputs separately and independently (e.g. via multiple distinct modules, as shown in FIG. 1A) to a format suitable for long short-term memory neural networks. Examples of embedding operations have been described herein and include embedding the data fields into a format which LSTM models understand. Such embedding may include converting or mapping each word sequence (e.g. vocabulary) into a fixed length vector having a defined size which represents the input words. As noted earlier, in at least some aspects, some of the data fields may have been pre-processed by a sequence to sequence model executed on the computing device 200 such as the neural network system 106 to convert data fields (e.g. from jargon into understandable text).

At operation 708, each embedded vector sequence is fed separately into a different and separate LSTM model (e.g. first LSTM 118 and second LSTM 122). The separate LSTMs allow different types of input fields (e.g. metadata attributes) to be fed into the model and allow the model to generate classification even when not all data fields are present such that the computing device 200 can still proceed with performing metadata classification.

At operation 710, the different outputs from the different LSTM models are concatenated in a shared layer to form a concatenated output such that hard parameter sharing is applied in this layer to share hidden model parameters of the multi-task machine learning model 140 across all tasks examined by the model.

At operation 712, following operation 710, all these features concatenated in the shared layer are fed to multiple classifier each configured for different tasks and that are optimized and simultaneously trained to recognize multiple tasks in combination. As shown in FIG. 1A, in the dense layer 127, a task 1 126A classifier may detect metadata classification for a first metadata task while a task 2 126B classifier may detect classification for a second metadata task, etc. The tasks 126 classifier having been trained simultaneous to optimize for multiple tasks and grabbing common feature to predict for the classes for which a particular classifier is tuned to. During the training of the model, operations of the computing device 200 utilize the same input for all tasks, and generate outputs for each specific task. An example set of output metadata labels 502 having a plurality of task classifications and associated values are shown in FIG. 5. As described earlier, in the task-specific layer 146, there are weights associated to the loss function of each task. In the multi-task learning process of operation 712, operations of the computing device 200 configure optimizing multiple loss functions for tasks simultaneously using a weighted loss function to perform multi-objective optimization. One goal performed at operation 712 by the task-specific layer of the computing device 200 is to find a pareto optimal solution that achieves a balanced trade-off for all the optimized tasks (i.e. loss functions).

Conveniently, operations 700 of the computing device 200 provide a generalized multitask machine learning model which satisfies the needs for multiple tasks at the same time. Advantageously, the methods and systems of the metadata classifier 120 and the machine learning model 140 save the training time required for the computing device 200 to train the neural network models as the computing device 200 is configured to train a single multitask machine learning model for several classification tasks. Multi-task learning performed in operation 712 also avoids overfitting and provides fast learning model 140 by leveraging shared tasks' information (e.g. as observed in shared layer 144 during operation 710).

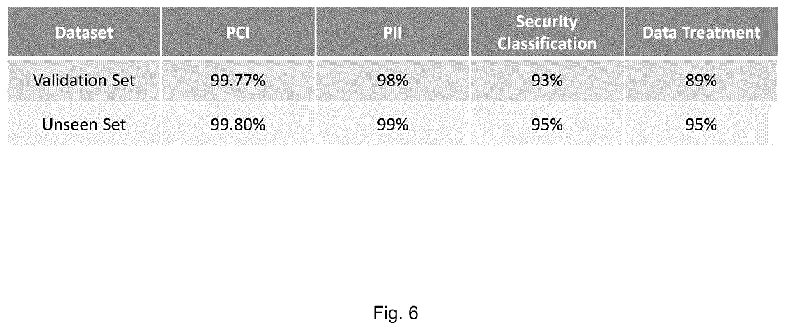

An example performance of the model 140 during validation and testing is shown at FIG. 6, including the various example classification tasks detected by the model via operations of the computing device 200 to automatically generate and tag metadata labels.

The machine learning model of claim 1, wherein the first textual input comprises: a business name field and a description field for an input data element, and the second textual input comprises: a malicious code field and a technical name field for the input data element.

In at least some aspects, operations of the computing device 200 utilize a particularly configured sequence to sequence deep learning model, such as the neural network system 106 for performing machine translation of one or more input text fields for the data elements prior to the operation 702. Such operations convert metadata fields for the data elements into a recognizable format for the multi-task learning model. The sequence to sequence model implemented by the neural network system 106 of FIGS. 1A, 1B and 2 may include an encoder layer, an attention layer and a decoder layer for receiving the data elements as a sequence containing textual input representing a first domain language including a name with acronyms and translating to a second domain language including an understandable text for each data element, the understandable text provided as input to the multi-task learning model for further processing as a further aspect of the metadata. Once such a machine translation is complete, operations of the computing device 200 apply the output resulting sequence to comprise one of the textual inputs in operations 702 or 704.

In one aspect, operations of the computing device 200 further apply an optimization layer (e.g. optimization layer 148 shown in FIG. 1A) subsequent to the operation step 712, to receive outputs from each task sublayer of a plurality of task sublayers provided as multi task classifiers comprised in the task specific layer and operations of the computing device 200 configure the computing device 200 to determine an indication of a likelihood of an input to the task specific layer corresponding to one of the task sublayers such that the outputs are provided to a root mean square propagation in the optimization layer for increasing a learning rate for the task specific layer.

In another aspect, operations of the computing device 200 may apply, in operation step 712 in the task specific layer 146, a binary threshold (e.g. see dropout layer 129 in FIG. 1A applying a binary threshold to task 1 output) to at least some output nodes to determine a likelihood of whether input to the task specific layer 146, e.g. the data element under consideration, falls within the particular task for the output layer to provide the metadata classification related to the particular task.

In another aspect, operations of the computing device 200 may apply, in operation step 712, at the task specific layer 146, (e.g. the dropout layer 129), a soft max threshold to at least some output nodes to determine a likelihood of whether input to the task specific layer falls within the particular task associated with one of the output nodes.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium. By way of example, and not limitation, such computer-readable storage media can comprise RAM, ROM, EEPROM, optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using wired or wireless technologies, such are included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more general purpose microprocessors, application specific integrated circuits (ASICs), field programmable logic arrays (FPGAs), digital signal processors (DSPs), or other similar integrated or discrete logic circuitry. The term “processor,” as used herein may refer to any of the foregoing examples or any other suitable structure to implement the described techniques. In addition, in some aspects, the functionality described may be provided within dedicated software modules and/or hardware. Also, the techniques could be fully implemented in one or more circuits or logic elements. The techniques of this disclosure may be implemented in a wide variety of devices or apparatuses, an integrated circuit (IC) or a set of ICs (e.g., a chip set).

One or more currently preferred embodiments have been described by way of example. It will be apparent to persons skilled in the art that a number of variations and modifications can be made without departing from the scope of the disclosure as defined in the claims.

What is claimed is:

1. A machine learning model for metadata classification and labelling comprising:
a multi-task learning model comprising:
an input layer for receiving a first textual input characterizing one aspect of metadata for an input data element; and receiving a second textual input characterizing another aspect of metadata for the input data element;
an embedding layer of the input layer, for embedding the first and second textual inputs separately and independently to a format suitable for long short term memory (LSTM) neural networks and each provided to a separate LSTM model in the input layer to generate a first and second output of the input layer respectively;
a shared layer for receiving the first and second output of the input layer from each LSTM and concatenating the outputs to form a concatenated output, the shared layer subsequently applying hard parameter sharing for sharing model parameters including hidden layers across all tasks; and
a task specific layer for receiving the concatenated output including the hard parameter sharing to learn parameters specific to each task and classifying the concatenated output into at least one of a possible set of tasks corresponding to separate metadata classifications using a set of simultaneously trained classifiers, the multi-task learning model being a single model trained to simultaneously learn, during a training phase, multiple classification tasks corresponding to different metadata classifications.

2. The machine learning model of claim 1, wherein the first textual input comprises: a business name field and a description field for the input data element, and the second textual input comprises: a malicious code field and a technical name field for the input data element.

3. The machine learning model of claim 1 further comprising:
a sequence to sequence deep learning model for converting metadata fields for data elements into a recognizable format for the multi-task learning model, the sequence to sequence model having an encoder layer, an attention layer and a decoder layer for receiving the data elements as a sequence containing textual input representing a first domain including a name with acronyms and translating to a second domain including an understandable text for each data element, the understandable text provided as input to the multi-task learning model for further processing as a further aspect of the metadata.

4. The machine learning model of claim 3, wherein the sequence to sequence deep learning model further applies long short term memory as the encoder and the decoder layers.

5. The machine learning model of claim 1 further comprising: an optimization layer coupled to the task specific layer, for receiving outputs from each task sublayer of a plurality of task sublayers providing multi task classifiers comprised in the task specific layer for determining an indication of a likelihood of an input to the task specific layer corresponding to one of the task sublayers, the outputs provided to a root mean square propagation in the optimization layer for increasing a learning rate for the task specific layer.

6. The machine learning model of claim 5, wherein the task specific layer applies deep multi-task learning and comprises an input layer, a hidden layer and an output layer, each node in the output layer associated with a particular task of a set of tasks and sharing common features therebetween for optimization of the multi-task learning.

7. The machine learning model of claim 6, wherein the task specific layer applies a binary threshold to at least some output nodes to determine a likelihood of whether input to the task specific layer falls within the particular task for the output layer to provide the metadata classification.

8. The machine learning model of claim 6, wherein the task specific layer applies a soft max threshold to at least some output nodes to determine a likelihood of whether input to the task specific layer falls within the particular task associated with one of the output nodes.

9. A computer-implemented method for metadata classification and labelling of data elements using machine learning, the method comprising:
receiving a first textual input, via an input layer of a multi-task learning model of a metadata classifier, for characterizing one aspect of metadata for an input data element; and receiving a second textual input characterizing another aspect of metadata for the input data element;
embedding, via an embedding layer of the input layer, the first and second textual inputs separately and independently to a format suitable for long short term memory (LSTM) neural networks;
providing each embedding to a separate LSTM model in the input layer to generate a first and second output of the input layer respectively;
receiving the first and second output of the input layer from each LSTM model, at a shared layer coupled to the input layer, and concatenating the outputs to form a concatenated output, the shared layer subsequently applying hard parameter sharing for sharing model parameters including hidden layers across all tasks;
receiving, at a task specific layer coupled to the shared layer, the concatenated output for including the hard parameter sharing to learn parameters specific to each task and classifying, at the task specific layer, the concatenated output into at least one of a possible set of tasks corresponding to separate metadata classifications using a set of simultaneously trained classifiers, the multi-task learning model being a single model trained to simultaneously learn, during a training phase, multiple classification tasks corresponding to different metadata classifications;
automatically tagging the input data element with the metadata classifications; and
communicating the tagged input data element with the metadata classifications to a requesting computing device, via a communication device coupled to the metadata classifier to process the tagged input data element.

10. The method of claim 9, wherein the first textual input comprises: a business name field and a description field for the input data element, and the second textual input comprises: a malicious code field and a technical name field for the input data element.

11. The method of claim 9, further comprising:
converting metadata fields for data elements into a recognizable format for the multi-task learning model via a sequence to sequence deep learning model, the sequence to sequence model having an encoder layer, an attention layer and a decoder layer for receiving the data elements as a sequence containing textual input representing a first domain including a name with acronyms and translating to a second domain including an understandable text for each data element, the understandable text provided as input to the multi-task learning model for further processing as a further aspect of the metadata.

12. The method of claim 11, wherein the sequence to sequence deep learning model further applies long short term memory as the encoder and the decoder layers.

13. The method of claim 9 further comprising: receiving outputs from each task sublayer of a plurality of task sublayers providing multitask classifiers comprised in the task specific layer to determine an indication of a likelihood of an input to the task specific layer corresponding to one of the task sublayers, the outputs provided to a root mean square propagation in the optimization layer for increasing a learning rate for the task specific layer.

14. The method of claim 13, further comprising: wherein the multi-task learning model performs deep multi-task learning and comprises an input layer, a hidden layer and an output layer, each node in the output layer associated with a particular task of a set of tasks and sharing common features therebetween for optimization of the multi-task learning.

15. The method of claim 14 further comprising applying, via the task specific layer, a binary threshold to at least some output nodes to determine a likelihood of whether input to the task specific layer falls within the particular task for the output layer to provide the metadata classification.

16. The method of claim 14 further comprising applying via the task specific layer a soft max threshold to at least some output nodes to determine a likelihood of whether input to the task specific layer falls within the particular task associated with one of the output nodes.

17. The method of claim 14, further comprising: detecting a trigger event prior to performing the metadata classifications and automatically tagging the input data element, the trigger event including receiving an input, at the requesting computing device to initiate migration of the input data element to a computing cloud.

18. A computer program product comprising a non-transient storage medium storing computer readable instructions for metadata classification and labelling of data elements using machine learning, wherein the instructions when executed by a processor of a computing device, cause the computing device to:
receive a first textual input, via an input layer of a multi-task learning model of a metadata classifier, for characterizing one aspect of metadata for an input data element; and receiving a second textual input characterizing another aspect of metadata for the input data element;
embed, via an embedding layer of the input layer, the first and second textual inputs separately and independently to a format suitable for long short term memory (LSTM) neural networks;
provide each embedding to a separate LSTM model in the input layer to generate a first and second output of the input layer respectively;
receive the first and second output of the input layer from each LSTM model, at a shared layer coupled to the input layer, and concatenating the outputs to form a concatenated output, the shared layer subsequently applying hard parameter sharing for sharing model parameters including hidden layers across all tasks;
receive, at a task specific layer coupled to the shared layer, the concatenated output for including the hard parameter sharing to learn parameters specific to each task and classifying, at the task specific layer, the concatenated output into at least one of a possible set of tasks corresponding to separate metadata classifications using a set of simultaneously trained classifiers, the multi-task learning model being a single model trained to simultaneously learn, during a training phase, multiple classification tasks corresponding to different metadata classifications;
automatically tag the input data element with the metadata classifications; and
communicate the tagged input data element with the metadata classifications to a requesting computing device, via a communication device coupled to the metadata classifier to process the tagged input data element.
